(19) United States
(12) Patent Application Publication
(10) Pub. No.: US 2018/0260234 A1
(43) Pub. Date: Sep. 13, 2018

(54) DEVICE BEHAVIOR MODELING BASED ON EMPIRICAL DATA

(71) Applicant: Bsquare Corp., Bellevue, WA (US)

(72) Inventors: David Wagstaff, Lake Forrest, CA (US); Matthew Honaker, Seattle, WA (US)

(21) Appl. No.: 15/898,033

(22) Filed: Feb. 15, 2018

Related U.S. Application Data
(60) Provisional application No. 62/468,622, filed on Mar. 8, 2017.

(51) Int. Cl. G06F 9/455; G06N 7/00

(52) U.S. Cl. CPC G06F 9/45508; G06N 7/005

(57) ABSTRACT

State and transition behavior data is collected from a machines and a clusterer is automatically selected to statistically group machines and machine elements. Finite states are generated from the state and transition data and used to create a machine emulator to model machine behavior. The machine emulator is then operated to predict and troubleshoot other possible states.

### CROSS REFERENCE TO RELATED APPLICATIONS

This application claims the benefit of U.S. provisional patent application Ser. No. 62/468,622, filed on Mar. 8, 2017, the contents of which are incorporated by reference herein in their entirety.

### BACKGROUND

Thousands of hours are invested in troubleshooting and maintenance of machine faults. Problems arising from engineering errors, incorrect operation, faulty parts and patterns of operator behavior may all lead to malfunction and/or damage of the machines involved. Many of the processes utilized to operate and maintain machinery may cause breakdowns over time for certain groups of users while leaving others unaffected and allowing the root cause to go undetected.

Current methods of determining and instituting best practices for the operation of machines may require many iterations and adjustments after gathering maintenance and user feedback of problems which have already occurred. This feedback may often be qualitative in nature, making definitions of the issue, and identification of the root causes difficult to determine.

Additionally, many underlying factors which may contribute to failures and reductions in operational efficiency may not readily be apparent, while other symptoms may be obvious, which may contribute to a spurious qualitative association between the cause and the outcome. Current machine modeling techniques designed to circumvent these problems fall short due to a lack of automation and adaptability when determining associations between device features, device instances and events.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a system for device behavior modeling based on empirical data 100.

FIG. 2 illustrates an embodiment of a process 200.

FIG. 3 illustrates an embodiment of a system for device behavior modeling based on empirical data 300.

FIG. 4 illustrates an embodiment of a finite state machine 400.

FIG. 5 illustrates an embodiment of a Markov matrix 500.

FIG. 6 illustrates an embodiment of a finite state machine 600.

FIG. 7 illustrates an embodiment of a system for device behavior modeling based on empirical data 700.

FIG. 8 illustrates an embodiment of a system for device behavior modeling based on empirical data 800.

FIG. 9 illustrates a system 900 in accordance with one embodiment.

### DETAILED DESCRIPTION

A system is disclosed to construct and utilize empirical models of device operation. Markov chains and Finite State Machines (FSM) may be utilized to construct an empirical model to model the operations and life cycle of machines. The present system and method allow for the autonomous definition of states and assembly of FSMs, exploring a Markov chain with an unknown structure through the use of associative grouping and collecting historical and “time-stamped” data. Nodes (machines/devices, features of devices, etc) may be clustered using standard techniques (k-means, k-medians, or similar) using available information about those devices. The precise grouping or clustering algorithm best employed should generally be based on data driven decisions and the full fidelity and end state desired to address the system as a whole. Then, the historical data about the devices may be used to trace the path from one cluster to the next. This gives the transition rate and, from the counts of transitions, an estimate of the transition probability. Transitions between nodes (edges) may be constructed from the probability of moving from one cluster to another cluster, determined by counts or other statistical methods used to estimate probabilistic transitions, but defined by changes in the variables which comprise the individual node or state. Due to the nodes in the system being comprised of states and variables grouped by unsupervised associative grouping there is some latent similarity to all items in that state, and that state is completely described by the variables used for the associative grouping. This allows for insights which may not be not obtainable through solely manual classification of states, providing information about both the probability of any given set of variables changing, and the direction of the change toward or away from specific nodes. Moreover, those probabilities may further be used as weights. Associative grouping may be accomplished through a statistical process, for example, k-means, partial least squares discriminant analysis, and Pearson's chi-squared test or may be accomplished through manual expert intervention, or through associations of variables with other variables, for example, finding all events which occur closely in time to another specified event. Expert input may, for example be given as a starting point (for example, a specific type of event) and then further events and microstates may be analyzed to determine their association with the expert-provided event. By way of example, an expert automotive technician may specify a loss of oil pressure at a specific moment, and associations with surrounding variables would be analyzed to isolate associated events and states.

Based-on discovered states and transitions, a FSM may be assembled with the nodes depicting possible states of the system, or machine (device), and the edges depicting possible transitions between the states, each associated with a rate. Multiple FSMs may also be constructed in order to model more complex systems where states may be found to be overlapping and non-exclusive in a global sense.

Once constructed, the system may apply the FSMs to reliability and failure analysis of machines. Tracing paths between nodes may show the probabilities of certain states occurring and thereby also show paths of transition of current states back to previous states. Path-tracing may incorporate associative grouping, and the use of time as a component when tracing transitions between nodes, highly probable, but very slow transitions may be discovered along with fairly improbable, but very fast transitions. The system may find the shortest, and thus most probable path between nodes; for example, Dijkstra's algorithm may be used. This allows the system to find paths which attempt to increase the likelihood of reaching and remaining in favorable states by “short-circuiting” the most probable paths, in favor of less probable but more favorable paths. Changes in the variables used for associative grouping may be correlated along the probabilistic pathways, which may uncover information previously too obfuscated to be revealed. Further, provided that definitions of nodes and edges in a machine follow Markovian constraints, a Markov model or chain may be built, which would allow efficient computation of mean time to failure and transient instantaneous failure rate.

A method may include collecting state and transition behavior data from a group of instances of a machine, operating an associative grouping logic selector to select associative grouping logic from an associative grouping logic list, applying the associative grouping logic to the state and transition behavior data to generate self-defined finite states by associative grouping a group of microstates, constructing machine emulation from the finite states, and/or operating the machine emulation with an initial finite state, a temporal direction and a transition number to generate a machine insight.

The machine emulation may be a digital representation of machine behavior based on a finite state machine, and may be version controlled through update logic. Operating the update logic may further include implementing a previous version of the machine emulation from a version history. Multiple instances of machine emulations may be constructed to emulate different aspects of machine behavior within a cluster. Initiating the update logic operation may be accomplished via a user interface. The state and transition behavior data may be collected via a cloud server. Machine insights generated may further include estimations of a resulting state. Operating the update logic may also include collecting the state and transition behavior data from a group of the machine instances, operating the associative grouping logic to generate the finite states and constructing an updated version of the machine emulation.

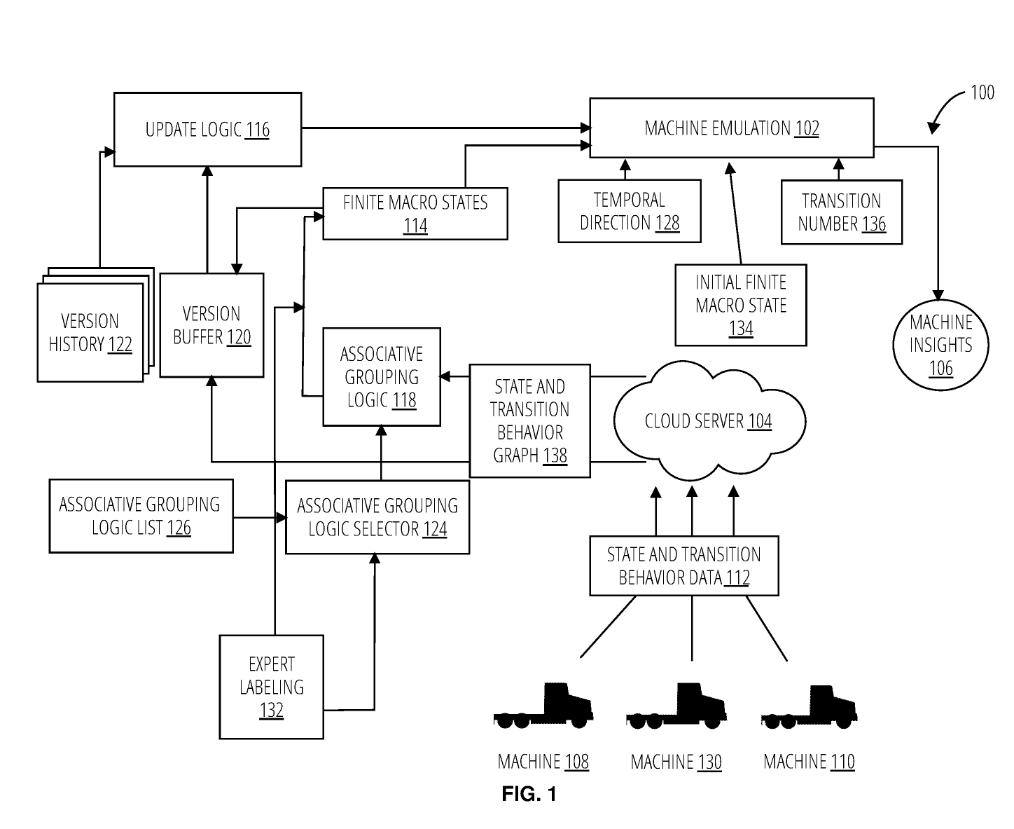

FIG. 1 illustrates an embodiment of a system for device behavior modeling based on empirical data 100.

The system for device behavior modeling based on empirical data 100 comprises a machine emulation 102, a cloud server 104, a machine insights 106, a machine 108, a machine 110, a state and transition behavior data 112, a finite states 114, an update logic 116, associative grouping logic 118, a version buffer 120, a version history 122, an associative grouping logic selector 124, an associative grouping logic list 126, a temporal direction 128, a machine 130, an initial finite state 134, and a transition number 136.

The cloud server 104 collects state and transition behavior data 112 from machine 108, machine 130, and machine 110. The associative grouping logic selector 124 automatically selects the associative grouping logic 118 from the associative grouping logic list 126. based on the data, the cluster selector may dynamically select an appropriate associative grouping mechanism from the associative grouping logic list 126 without human supervision. The associative grouping logic 118 receives the state and transition behavior data 112 and groups microstates into more global finite macrostates 114. The finite states 114 are deployed as machine emulation 102. The version buffer 120 receives updated state and transition behavior data from the cloud server 104 and updated finite states 114 from the associative grouping logic 118. The update logic 116 updates the version of the machine emulation 102 currently deployed. By version controlling the machine emulation 102 in this manner, constant iterative updates can be made to improve the model. The update logic may also update the machine emulation 102 with a previous version from version history 122. The machine emulation 102 may be operated with the temporal direction 128, the initial finite state 134 and the transition number 136 to produce the machine insights 106.

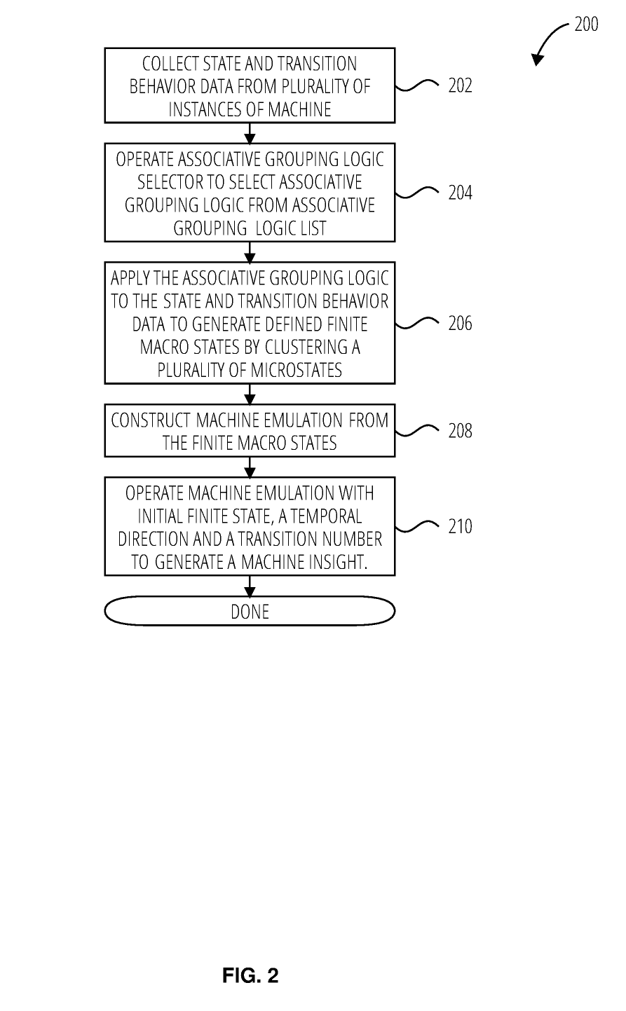

The system for device behavior modeling based on empirical data 100 may be operated in accordance with the process outlined in FIG. 2.

Referring to FIG. 2, the process 200 comprises collecting state and transition behavior data from a plurality of instances of a machine (block 202). The associative grouping logic selector is operated to select associative grouping logic from an associative grouping logic list (block 204). The associative grouping logic is applied to the state and transition behavior data to generate defined finite states by associative grouping a plurality of microstates (block 206). The microstates of a given system in this context may be defined largely by the representative physical units of the system. Any global system may be described by a series of microstates (thermodynamically and entropically if in no other manner), though there may conceivably be infinitely many of these microstates used to describe the full path though the state machine. In practice, it is likely that each individual device or object represents a single microstate, unless two or more are indistinguishable, at which point these together constitute the microstate. Establishing the macrostates, to which may similar members belong, is a function of either states defined as distance by an expert in the field, or though associative grouping distance metrics and success criteria. A machine emulation is then constructed from the finite states (block 208). The machine emulation is operated with an initial finite state, a temporal direction and a transition number to generate a machine insight (block 210).

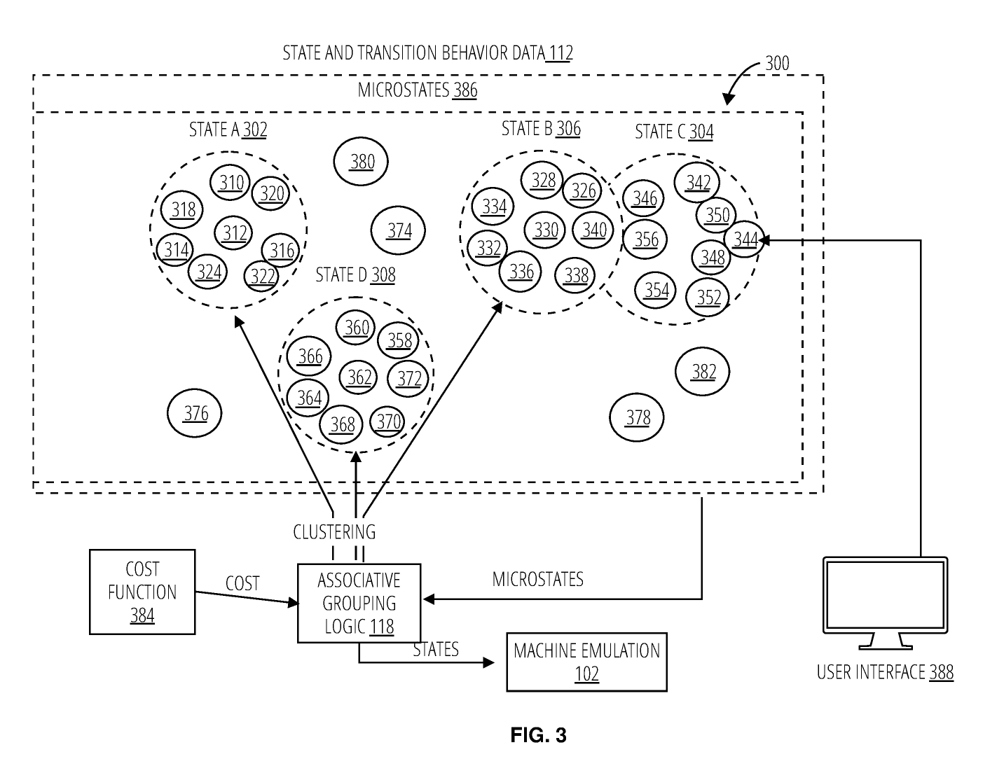

The FIG. 3 illustrates an embodiment of a system for device behavior modeling based on empirical data 300.

The system for device behavior modeling based on empirical data 300 comprises a machine emulation 102, a state and transition behavior data 112, associative grouping logic 118, a state a 302, a state c 304, a state b 306, a stated 308, a microstate 310, a microstate 312, a microstate 314, a microstate 316, a microstate 318, a microstate 320, a microstate 322, a microstate 324, a microstate 326, a microstate 328, a microstate 330, a microstate 332, a microstate 334, a microstate 336, a microstate 338, a microstate 340, a microstate 342, a microstate 344, a microstate 346, a microstate 348, a microstate 350, a microstate 352, a microstate 354, a microstate 356, a microstate 358, a microstate 360, a microstate 362, a microstate 364, a microstate 366, a microstate 368, a microstate 370, a microstate 372, a microstate 374, a microstate 376, a microstate 378, a microstate 380, a microstate 382, a cost function 384, a microstates 386, and a user interface 388.

The state and transition behavior data 112 further comprises the microstates 386.

State 0 402 further comprises the microstate 310, the microstate 312, the microstate 314, the microstate 316, the microstate 318, the microstate 320, the microstate 322, and the microstate 324.

State 1 406 further comprises the microstate 326, the microstate 328, the microstate 330, the microstate 332, the microstate 334, the microstate 336, the microstate 338, and the microstate 340.

State c 304 further comprises the microstate 342, the microstate 344, the microstate 346, the microstate 348, the microstate 350, the microstate 352, the microstate 354, and the microstate 356.

State 3 408 further comprises microstate 358, the microstate 360, a microstate 362, the microstate 364, the microstate 366, the microstate 368, the microstate 370, and the microstate 372.

The associative grouping logic 118 may run in a central location, such as cloud server 104 so that it may have access to all available data. In addition to the associative grouping logic 118 defining states, a user may utilize user interface 388 to manually define a state. The associative grouping logic 118 groups multiple similar instances of the observed machines together into individual clusters, and each individual cluster may have its underlying systems and features modeled with an individual finite state machine. The finite state machines composition and therefore operation may differ between clusters of machines modeled. The associative grouping logic 118 may utilize a cost function 384 to balance the composition and size of the clusters with the computation time. The cost function may currently be .2, but may also be adjusted by the user to adapt to changing needs.

The associative grouping logic 118 groups microstate 310, the microstate 312, the microstate 314, the microstate 316, the microstate 318, the microstate 320, the microstate 322, and the microstate 324 into state 0 402.

The associative grouping logic 118 groups microstate 326, the microstate 328, the microstate 330, the microstate 332, the microstate 334, the microstate 336, the microstate 338, and the microstate 340 into state 1 406.

The user interface 388 may be configured to group the microstate 342, the microstate 344, the microstate 346, the microstate 348, the microstate 350, the microstate 352, the microstate 354, and the microstate 356 into state c 304.

The associative grouping logic 118 groups the microstate 358, the microstate 360, a microstate 362, the microstate 364, the microstate 366, the microstate 368, the microstate 370, and the microstate 372 into state 3 408.

The associative grouping logic 118 is configured by cost function 384 to leave microstate 380, the microstate 374, the microstate 376, the microstate 378 and the microstate 382. The associative grouping logic 118 may construct the machine emulation 102 from the state a 302, the state b 306, and the state d 308.

The lifecycle of a device, or possibly any physical object, may be traced as a series infinitely many microstates governed primarily by entropy in one direction and ‘repair’ in the other. These microstates may be grouped into macrostates separated by jumps, or transitions from one state to the next. The transitions between macrostates, hereafter referred to as states, may be the result of some amount of entropy accumulation and subsequent degradation, the result of some triggering event or condition, or a combination of both.

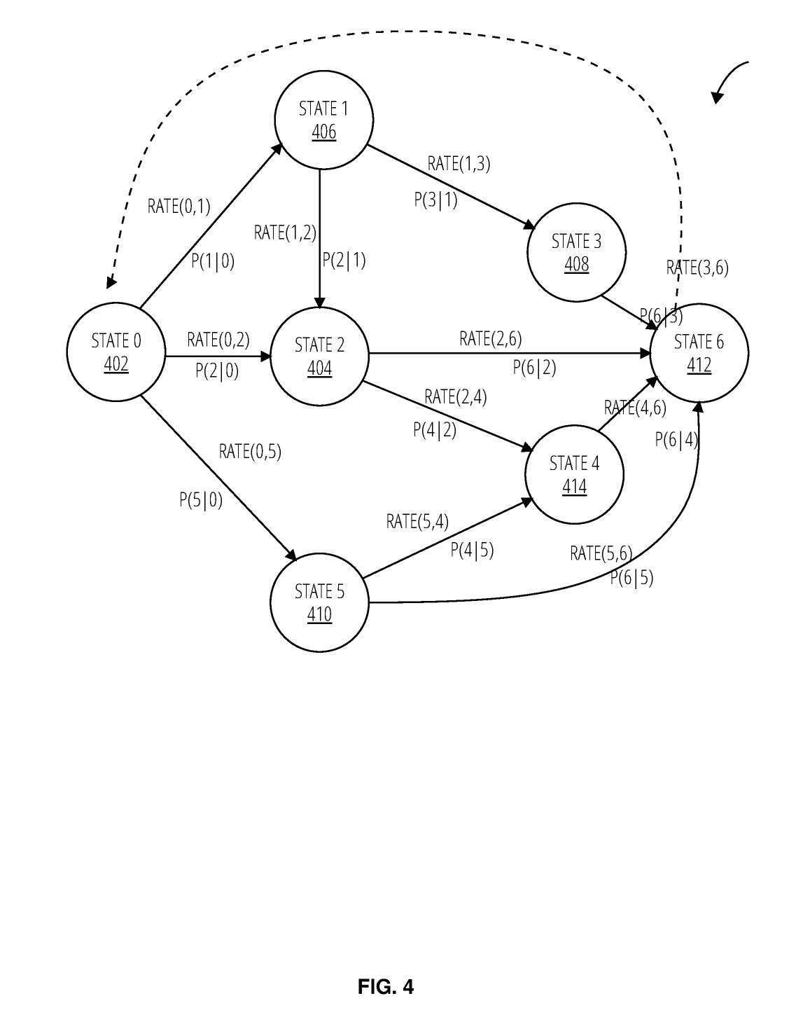

FIG. 4 illustrates an embodiment of a finite state machine 400.

The finite state machine 400 comprises a state 0 402, a state 2 404, a state 1 406, a state 3 408, a state 5 410, a state 6 412, and a state 4 414.

For modeling purposes, the number of states defined is finite, even if quite large. At this point, it seems clear that the states and transitions may be modeled as a directed graph, with the condition of state as nodes and transitions as edges. The precise definition of the state, and thus the information for any particular device's inclusion may be chosen at will, subject to certain constraints. Moreover, the definition of the transition path, and therefore the resulting connectivity of the graph, may also be formed of edges weighted for the desired utility of modeling. This graph may therefore model the lifecycle (or portion thereof) of a device. The state of the device is a node in a directed graph. The edges of this graph represent possible transition from one state to another. Depending on precisely how these nodes and edges are defined, then the graph can be modeled as finite-state machine, a Markov chain, or a Bayesian network.

This figure illustrates a number of possibilities. There are several states, state 0 402, state 1 406, state 2 404, state 5 410, state 3 408, state 4 414, and state 6 412. The starting state, at initialization time, is state 0 402. Considering only the solid paths for the moment, state 0 402 can only be exited, and state 6 412 can only be entered. This would then be an example of an absorbing Markov chain. State 0 402 may thought of as a new device, and state 6 412 the completely failed device, with the other states as relevant intermediate steps. On one side of each edge is a rate, and on the other is a conditional probability. In the discreet time case, the probability of being in any given state depends only on the starting state and number of steps taken, and may be conveniently calculated using a state vector and transition matrix. In the continuous time case, the probability of being in a state at time t depends on the rate of transition and the probability functions. Thus the holding time, or amount of time (in a distribution sense) left to remain in a state, is dependent only on the rate of exit from the state, and is thus exponential. As with the discreet time case, several properties of interest can be determined though the transition matrix. There also a number of different formulations of the continuous time Markov chain (CTMC), including cyclic version where repairs are made (the dotted line), or explosive versions where new devices are inserted, but none leave, and so forth.

A Bayesian network may work as well as frequentist methods of calculating probabilities. In this case the set of states (or even events) may be modeled as a directed acyclic graph with nodes as the set of states, which should still have some of the properties of random variables as before, but are not strictly stochastic insomuch as there does not have to be an evolution though time for the changes in states. That is, the transition is governed only by conditional probabilities, and the exact state of the system does not depend on the time (or number of steps) but only of the probability function of each node which takes as an input the parent nodes leading into it, and outputs the probability (or probability distribution) of the variable or state represented by the node. If nodes are not connected, they are conditionally independent. Typically, the network may be considered to be a complete model for the states and relationships under investigation, and thus may be used to formulate answers to probability related existence questions about the states. Additionally, new information may be easily incorporated by updating the priors, and the overall network is normally considered to be a method with which to apply Bayes theorem to complex problems. There are also a number of machine learning techniques which may be used (with varying degrees of success) to determine the structure and probabilities of an un-(or under) determined Bayes network.

Discrete state space Markov chains, in particular discrete time, and continuous time Markov chains may be used. In the discreet time example, the system remains in a given state for exactly one unit of time before making a transition (or state change). In this case, the path though the graph relies only on the probability of taking each step from each state, and you can calculate the probability of being in any state given the starting state from which you would like to calculate, and the number of time steps take. The drunkard's walk is a well-known example of this type of Markov chain, and can be either open ended, or absorbing if there is a final state(s) from which there is no exit. It is perhaps more realistic to consider that case where the system can remain in a state for a continuous amount of time. Now the probability of being in any given state is governed by the probability of transition with respect to a rate of transition.

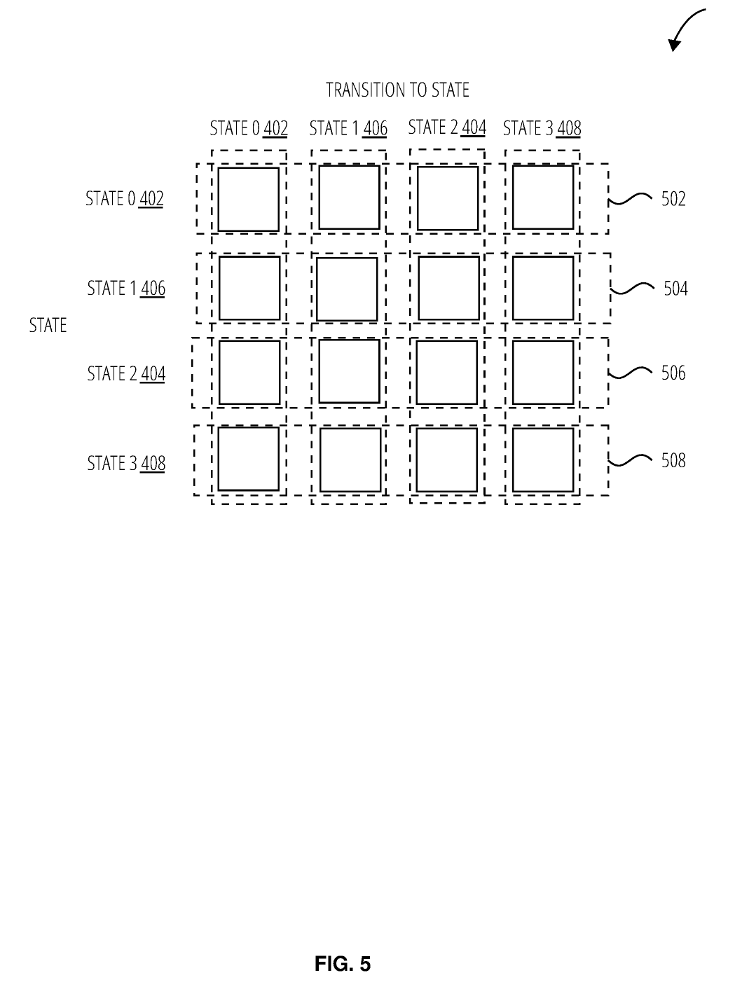

FIG. 5 illustrates an embodiment of a Markov matrix 500.

The Markov matrix 500 comprises a state 0 402, a state 2 404, a state 1 406, a state 3 408, a row vector 502, a row vector 504, a row vector 506, and a row vector 508.

The Markov matrix depicted shows the probability of transitioning to any other state for any given state. Row vector 502 shows the probabilities of state 0 402 transitioning to any other state. Row vector 504 shows the probability of state 1 406 transitioning to any other state. Row vector 506 shows the probability of state 2 404 transitioning to any other state. Row vector 508 shows the probability of state 3 408 transitioning to any other state.

A Markov matrix (also termed probability matrix, transition matrix, substitution matrix, or Markov matrix) is a matrix used to describe the transitions of a Markov chain. Each of its entries is a nonnegative real number representing a probability.

In the same vein, one may define a stochastic vector (also called a probability vector) as a vector whose elements are nonnegative real numbers which sum to 1. Thus, each row of a right stochastic matrix (or column of a left stochastic matrix) is a stochastic vector.

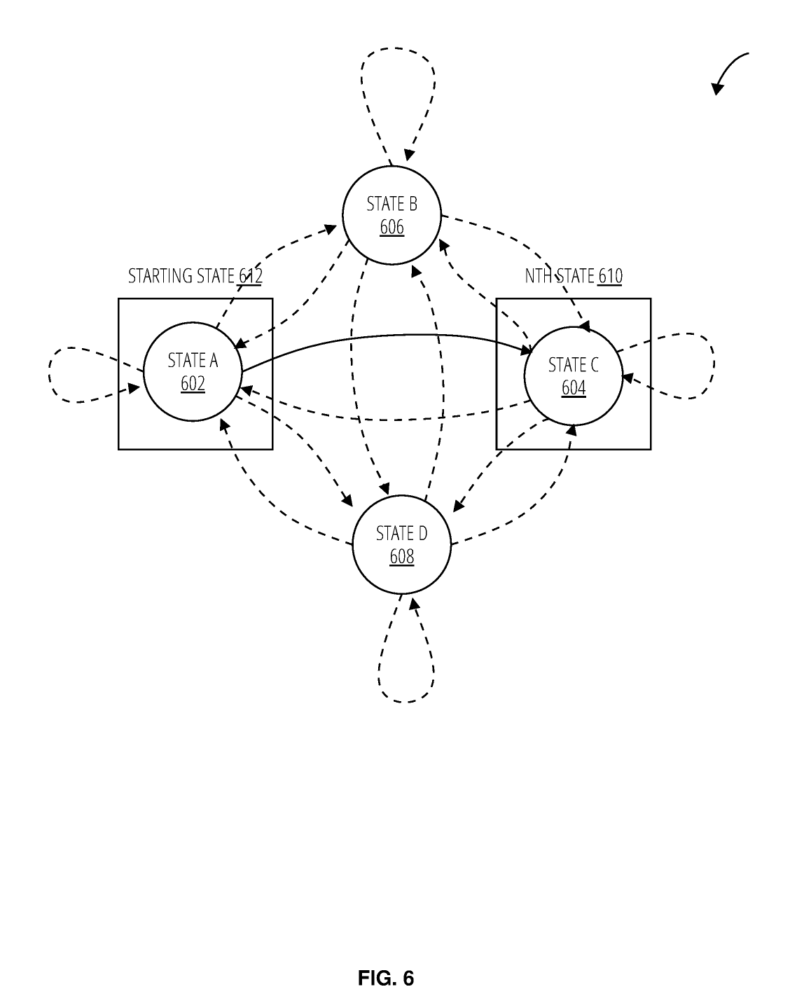

FIG. 6 illustrates an embodiment of a finite state machine 600.

The finite state machine 600 comprises a state a 602, a state c 604, a state b 606, a state d 608, a Nth state 610, and a starting state 612.

The state a 602 is the starting state 612 and transitions to the Nth state 610 (state c 604) after N number of steps. Transitions between state d 608 and state b 606 are also depicted.

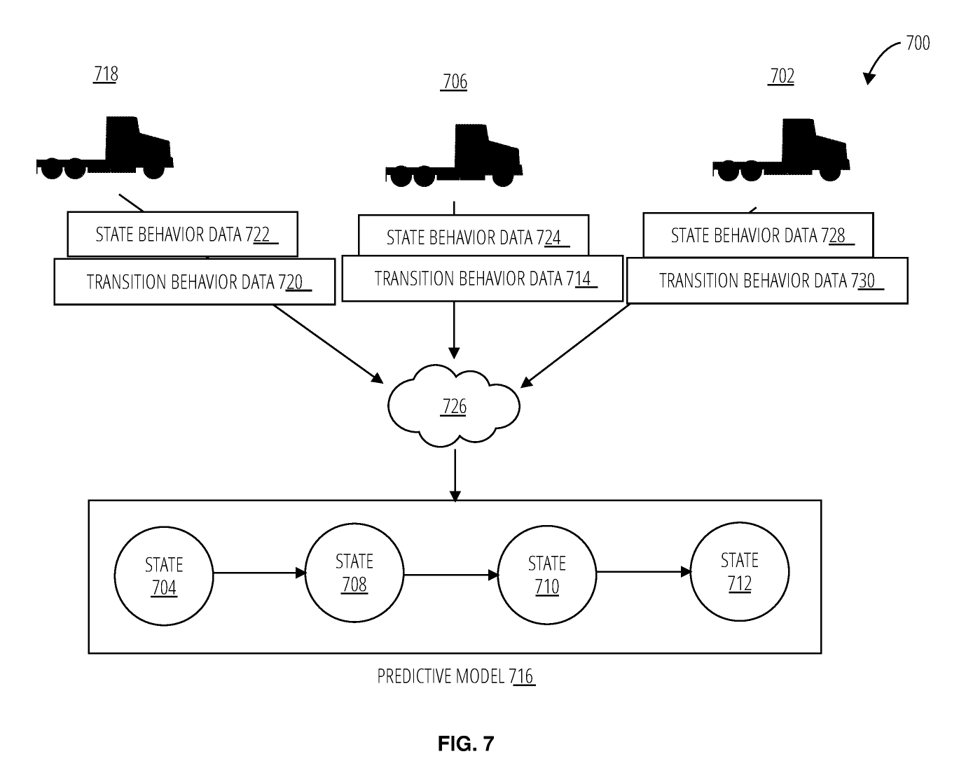

FIG. 7 illustrates an embodiment of a system for device behavior modeling based on empirical data 700.

The system for device behavior modeling based on empirical data 700 comprises a 702, a state 704, a 706, a state 708, a state 710, a state 712, a transition behavior data 714, a predictive model 716, a 718, a transition behavior data 720, a state behavior data 722, a state behavior data 724, a 726, a state behavior data 728, and a transition behavior data 730.

The 726 receives the state behavior data 722 and transition behavior data 720 from the 718 and the state behavior data 724 and transition behavior data 714 from the 706, and the state behavior data 728 and the transition behavior data 730 from the 702 the data is assembled into the predictive model 716 comprising a probabilistic model of progression from state 704 to state 708 to state 710 to state 712.

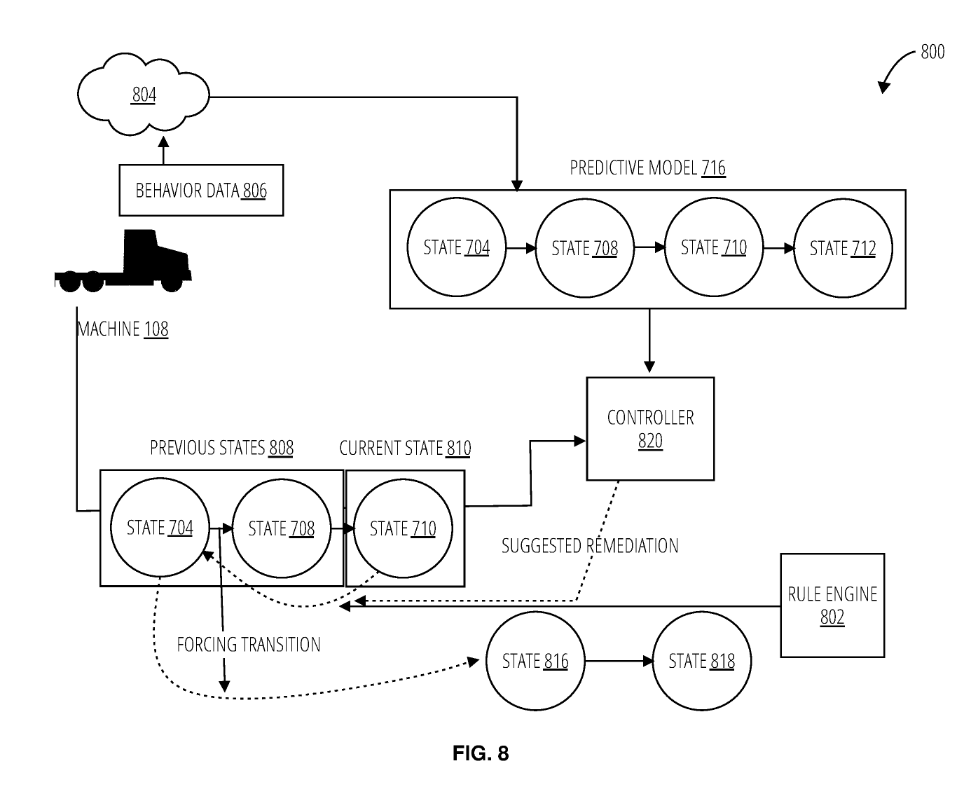

FIG. 8 illustrates an embodiment of a system for device behavior modeling based on empirical data 800.

The system for device behavior modeling based on empirical data 800 comprises a machine 108, a state 704, a state 708, a state 710, a state 712, a predictive model 716, an 804, a behavior data 806, a previous states 808, a current state 810, a state 816, a state 818, and a controller 820. The 804 recieves behavior data 806, from the machine 108 the 804 generates a predictive model 716 further comprising the state 704, the state 708, the state 710, and the state 712.

The controller 820 receives the predictive model 716, knowledge of the current state 810 of the machine 108 and the previous states 808 allows the controller 820 to and suggests a remediation to transition current state 710 back to state 704 and force a transition t0 state 816 and state 818, to keep the machine 108 from making the likely transition to state 712 from state 710.

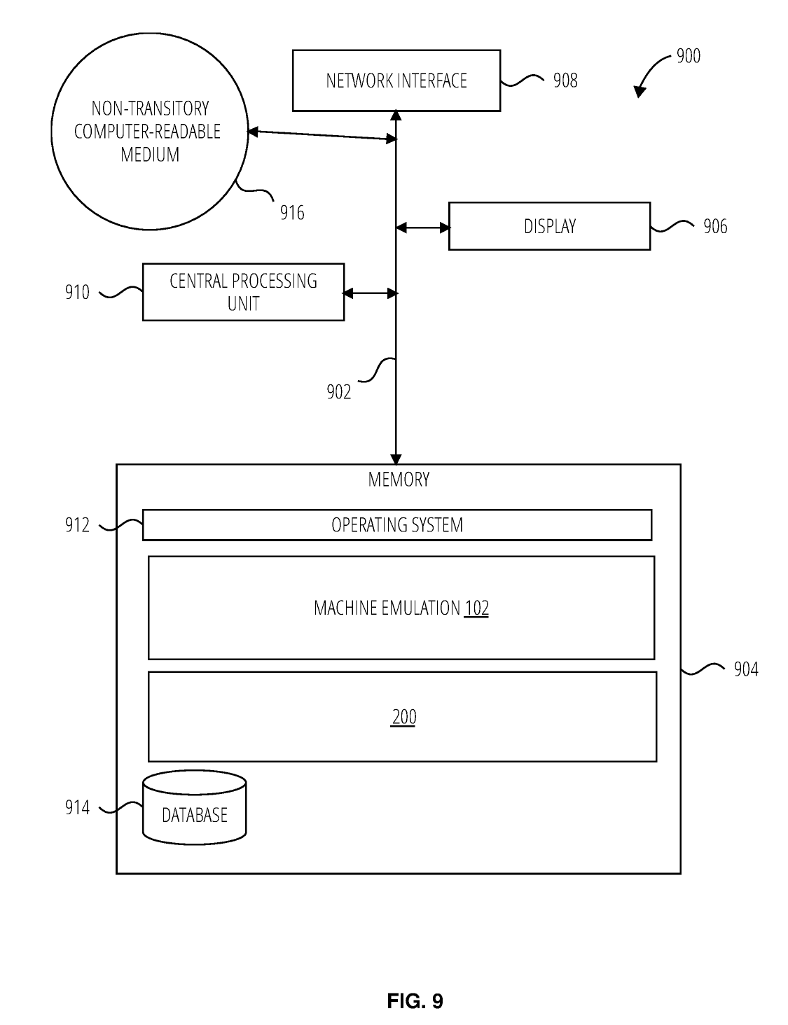

FIG. 9 illustrates several components of an exemplary system 900 in accordance with one embodiment. In various embodiments, system 900 may include a desktop PC, server, workstation, mobile phone, laptop, tablet, set-top box, appliance, or other computing apparatus or device that is capable of performing operations such as those described herein. In some embodiments, system 900 may include many more components than those shown in FIG. 9. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 900 may comprise one or more physical and/or logical devices that collectively provide the functionalities described herein. In some embodiments, system 900 may comprise one or more replicated and/or distributed physical or logical devices.

In some embodiments, system 900 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 900 includes a bus 902 interconnecting several components including a network interface 908, a display 906, a central processing unit 910, and a memory 904.

Memory 904 generally comprises a random access memory (“RAM”) and permanent non-transitory mass storage device, such as a hard disk drive or solid-state drive. Memory 904 stores an operating system 912.

These and other software components may be loaded into memory 904 of system 900 using a drive mechanism (not shown) associated with a non-transitory computer-readable medium 916, such as a DVD/CD-ROM drive, memory card, network download, or the like.

Memory 904 also includes database 914. In some embodiments, system 900 may communicate with database 914 via network interface 908, a storage area network (“SAN”), a high-speed serial bus, and/or via the other suitable communication technology.

In some embodiments, database 914 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Terminology and Interpretation

Terms used herein should be accorded their ordinary meaning in the relevant arts, or the meaning indicated by their use in context, but if an express definition is provided, that meaning controls.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however, this does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” in this context refers to logic implemented as processor-executable instructions in a machine memory (e.g. read/write volatile or nonvolatile memory or media).Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A computer-implemented method comprising:
collecting state and transition behavior data from a plurality of instances of a machine;
operating an associative grouping logic selector to select associative grouping logic from an associative grouping logic list;
applying the associative grouping logic to the state and transition behavior data to generate defined finite states by associatively grouping a plurality of microstates;
constructing a machine emulation from the finite states; and
executing the machine emulation with an initial finite state, a temporal direction and a transition number or probability to generate a machine insight machine output.

2. The method of claim 1, wherein the machine emulation is a digital representation of machine behavior based on a finite state machine.

3. The method of claim 1, wherein the state and transition behavior data are collected via a cloud server.

4. The method of claim 1, wherein the machine insight further comprises estimating a resulting state.

5. The method of claim 1, wherein multiple instances of the machine emulation are constructed to emulate different aspects of machine behavior within a cluster.

6. The method of claim 1, wherein the machine emulation is version controlled through update logic.

7. The method of claim 6, wherein operating the update logic further comprises implementing a previous version of the machine emulation from a version history.

8. The method of claim 6, wherein initiating the update logic is accomplished via a user interface.

9. The method of claim 6 wherein operating the update logic further comprises collecting the state and transition behavior data from a plurality of the machine instances, operating the associative grouping logic to generate the finite states and constructing an updated version of the machine emulation.

10. A computing apparatus, the computing apparatus comprising:
a processor; and
a memory storing instructions that, when executed by the processor, configure the apparatus to:
collect state and transition behavior data from a plurality of instances of a machine;
operate an associative grouping logic selector to select associative grouping logic from an associative grouping logic list;
apply the associative grouping logic to the state and transition behavior data to generate defined finite states by associative grouping a plurality of microstates;
construct machine emulation from the finite states; and
execute the machine emulation with an initial finite state, a temporal direction and a transition number or probability to generate a machine insight output.

11. The computing apparatus of claim 10, wherein the machine emulation is a digital representation of machine behavior based on a finite state machine.

12. The computing apparatus of claim 10, wherein the state and transition behavior data are collected via a cloud server.

13. The computing apparatus of claim 10, wherein the machine insight further comprises estimate a resulting state.

14. The computing apparatus of claim 10, wherein multiple instances of the machine emulations are constructed to emulate different aspects of machine behavior within a cluster.

15. The computing apparatus of claim 10, wherein the machine emulation is version controlled through update logic.

16. The computing apparatus of claim 15, wherein operating the update logic further comprises implementing a previous version of the machine emulation from a version history.

17. The computing apparatus of claim 15, wherein initiating the update logic is accomplished via a user interface.

18. The computing apparatus of claim 15 wherein operating the update logic further comprises collect the state and transition behavior data from a plurality of the machine instances, operating the associative grouping logic to generate the finite states and constructing an updated version of the machine emulation.
